(19) United States
(12) Patent Application Publication
(10) Pub. No.: US 2002/0117491 A1
(43) Pub. Date: Aug. 29, 2002

(54) Mobile soldering station

(76) Inventor: Robert C. Griffith, Woodland Hills, CA (US)

Correspondence Address: Daniel T. Anderson, 5000 East Lake Sammamish, Issaquah, WA, 98029, US

(21) Appl. No.: 09/794,892

(22) Filed: Feb. 26, 2001

(51) Int. Cl. H05B 1/00

(52) U.S. Cl. 219/231; 219/229; 228/51

(57) ABSTRACT

A portable soldering system is disclosed which includes a battery which may be charged from an external source; or the external source may directly supply the system. The output of the battery or other source is regulated to maintain a set temperature of the soldering tip irrespective of the instantaneous state of charge of the battery; and a voltage boost is automatically provided when needed for maintaining a set temperature for the soldering tip.

### BACKGROUND OF THE INVENTION

This invention relates generally to electric soldering tools and more particularly to a temperature controlled, battery operated, portable soldering iron.

There has long been a need for soldering and desoldering tools which can operate independently of AC line power sources and be therefore portable. Such a need is manifest, for example, in servicing or maintaining electric or electronic equipment in vehicles wherein line power is unavailable or in stationary places with difficult or tight access making the use of power supply cords inconvenient, impractical, or dangerous.

Previous approaches to providing portable soldering irons have included simple battery-soldering iron combinations and gas-fired or liquid fueled soldering irons. None of these approaches has provided temperature control of the soldering tip which, particularly with modem temperature sensitive micro-electronic components, has become a critically important criterion. Further, in the case of the simple battery system, the soldering tip may be too hot when the battery is charged and too cool and slow to be practical when the battery is not fully charged. A further difficulty is in the overall power drain from the battery: if it is to heat quickly, the rate of power consumption under quiescent or idle conditions is intolerably wasteful; and if a reasonable power consumption rate is provided for quiescent conditions, the heat-up time and temperature recovery during use is intolerably slow.

A further difficulty, typically, in the prior art is that to maximize the efficiency of the soldering tip and minimize battery drain, the electric heating element is integrated into the actual solder contacting tip. Thus when the electric element fails or burns out, the tip must be replaced. The disadvantages of such systems are that the tips are expensive and it is economically difficult to provide a full range of special purpose tips each with its own internal heater.

The disadvantages and limitations of gas or liquid combustion heating for soldering are obvious: not temperature controlled, difficult to comply with safety regulations, and inherently a fire or burn hazard. In addition, the safety concerns for transporting these fuel supplies in planes and boats are severe.

Accordingly, it is an object of this invention to provide a truly portable battery powered soldering station which has precision tip temperature control with very rapid initial heating and recovery during heavy use, and yet expends energy at a very low rate during quiescent or idle conditions.

It is another object to provide such a system which may automatically provide a special high voltage boost when desired for heat-up or recovery.

It is another object to provide such a soldering station which is capable of many hours of normal use in the field before requiring recharging with an internal battery system weighing only a few pounds.

It is another object to provide such a system which, using only readily available, state of the art components, is inexpensive to manufacture and maintain.

It is another object to provide such a system which typically operates from a 12 volt source, therefore minimizing the normally severe difficulties of complying with worldwide governmental, safety agency requirements regarding soldering iron approval.

### DESCRIPTIVE LISTING OF DRAWINGS

FIG. 1 is an overall block diagram of an electronic system for a mobile soldering station embodying the principles of the present invention;

FIG. 2A is a detailed circuit schematic diagram of the power supply portion of the diagram of FIG. 1;

FIG. 2B is a detailed schematic diagram of the remainder of the circuitry of FIG. 1;

FIG. 3 is a detailed schematic diagram of the boost switching regulator block of FIG. 1;

FIG. 4 is a detailed schematic diagram of the heater element block of FIG. 1;

FIG. 5 is a detailed schematic diagram of the drive level translator block of FIG. 1;

FIG. 6 is a detailed schematic view of the heater element supply switch block of FIG 1;

FIG. 7 is a detailed schematic diagram of the timing pulse generator block of FIG. 1;

FIG. 8 is a detailed schematic diagram of the time and control block of FIG. 1; and

FIG. 9 is a detailed schematic diagram of the temperature sensing circuitry block of FIG. 1.

### DETAILED DESCRIPTION OF PREFERRED EMBODIMENT

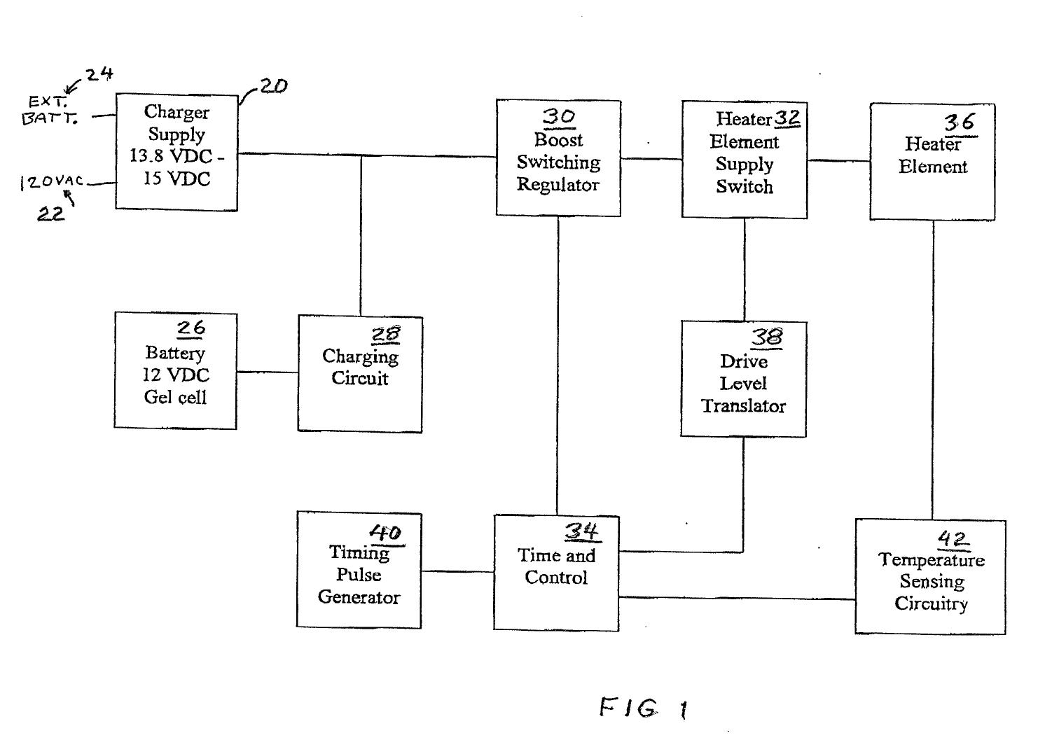

The example of the invention illustrated in FIG. 1 includes a charger supply 20 which may include a standard, plug-in “batter eliminator” supplying approximately 15 VDC from a 120 (or 240) VAC external source and/or an external batter source such as that from an automobile, aircraft, or other vehicle or remote equipment—these being usually 12 to 15 VDC depending upon their particular character and state of charge. It may be noted that the nominal 12 volt basic source, in this example of the invention, is chosen because of its universal availability worldwide. The inputs to the charger supply 20 may be a wall-plug “battery eliminator” indicated at 22 or an external battery supply 24 as from the cigarette lighter receptacle or other 12 to 15 VDC source which might be available from the vehicle or independent battery in the field.

The internal battery 26 may be a standard 12 volt sealed gel lead acid battery chosen for its low cost, high capacity, ease of charging, and sealed, maintenance-free character.

A charging circuit 28 is coupled between the power sources 20, 26 and the remainder of the control system which is fed directly from the supply 20. When power is drawn from the battery 26, it is limited and controlled by the charging circuit 28.

A boost switching regulator 30 is coupled to the supplies 20, 26 and provides an unregulated boost voltage of approximately 30 VDC to a heater element supply switch 32 under the control of a timing and control circuit 34. A heater element 33 in this example is a 24 volt 30 watt ceramic soldering iron heater having a positive temperature-resistance coefficient, whereby its resistance is a function of its temperature. The timing and control circuit 34 also drives the heater element supply switch 32 through a drive level translator circuit 38.

A timing pulse generator 40 produces a 2 HZ 5% duty cycle negative going pulse that is used to time a temperature sensing window (from the resistance of the heating element 33) and a heater turn-on time for the timing and control circuit 34.

A temperature sensing circuit 42 determines the temperature of the heating element 33, compares it to an operator-set temperature and, when not satisfactorily matched, provides a signal to the timing and control circuit 34 causing additional energization to be provided to the heating element 33.

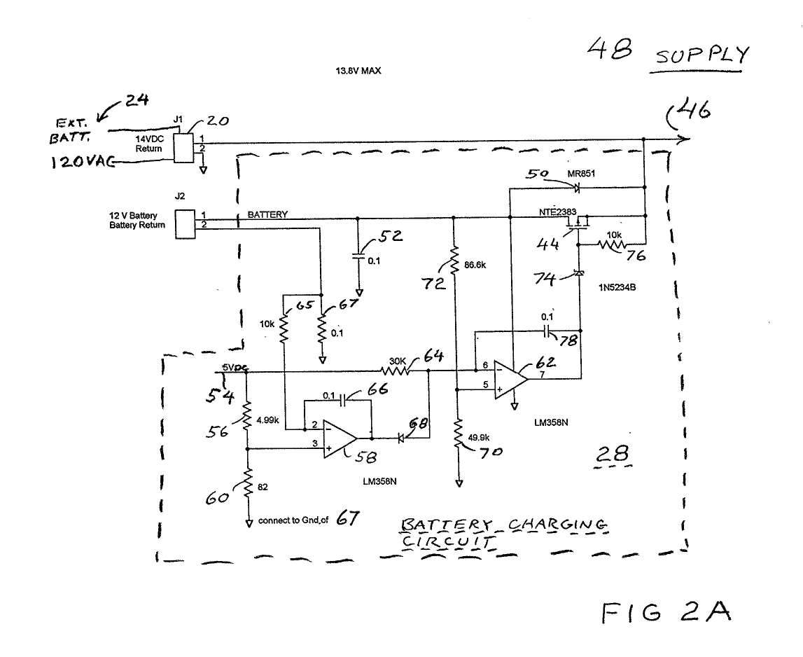

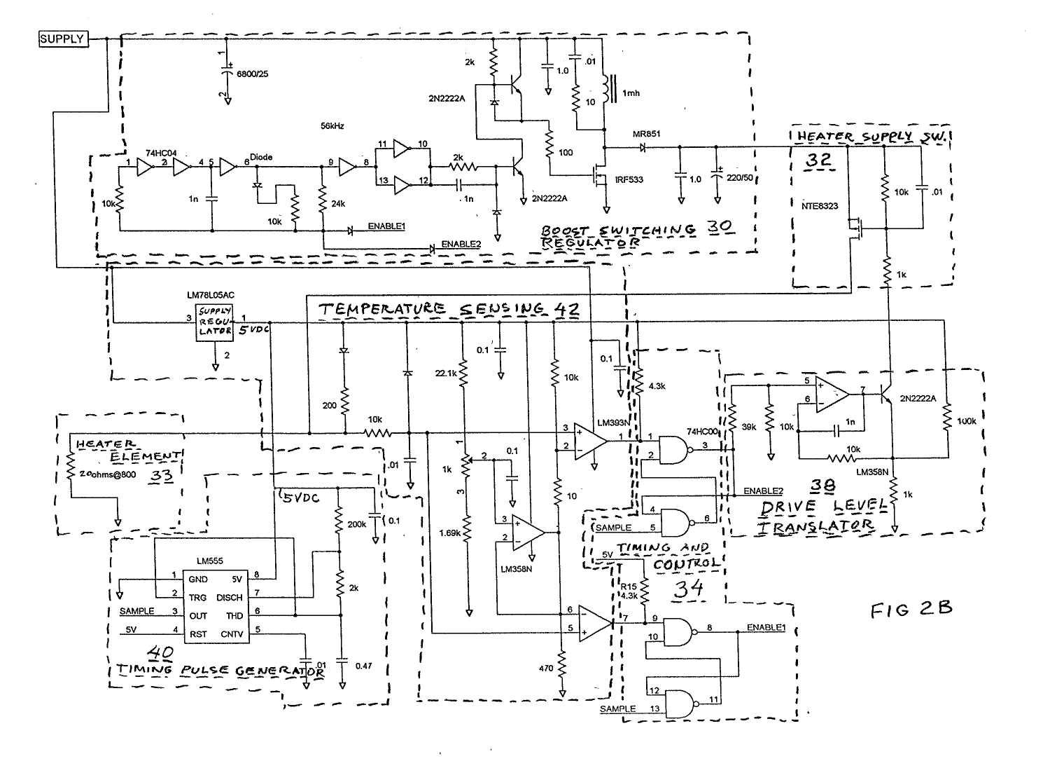

Referring to FIG. 2A, the battery 26 is seen to be coupled through a transistor 44 and a parallel diode 50 to the output 46 of the system supply 48. The transistor 44, in this example, is a power MOSFET (metal oxide silicon field effect transistor) or VMOS transistor available as NTE 2383. It is a P channel device such that no current is passed until a predetermined negative voltage is applied to its gate. The VMOS transistor provides the advantage that while the battery 26 is being charged, there is no saturation voltage and the voltage drop across it is very low at low charging currents; and it performs like a diode in the reverse direction. The parallel diode 50 supplements the VMOS transistor 44 because it has a high voltage drop in the forward direction. Thus it is a series pass transistor while charging and a series diode when the battery 26 is supplying more current than the charge source 20. A capacitor 52 of 0.2 microfarads is connected from the battery 26 to ground. A 5 volt supply bus 54 is connected through a resistor 56 of 4.99 k-ohms to terminal 3 of an operational amplifier 58 and to ground through a resistor 60 of 82 ohms. The supply bus is also connected to terminal 6 of an operational amplifier 62 through a resistor 64 of 30 k-ohms. The return of the battery 26 is coupled through a resistor 65 of 10 k-ohms to terminal 2 of the amplifier 58 and to ground through a resistor 67. The output of the amplifier 58 is connected to its terminal 2 by a capacitor 66 of 0.1 microfarads and to terminal 6 of the amplifier 62 through a diode 68.

The terminal 5 of the amplifier 62 is coupled through a resistor 70 of 49.9 k-ohms and to the pass transistor 44 on the battery side through a resistor 72 of 86.6 k-ohms. The gate of the pass transistor 44 is coupled to the output of the amplifier 62 through a Zener diode 74 available as IN5234B and to the output of the transistor by a resistor 76 of 10 k-ohms. Terminals 6 and 7 of the chip amplifier 62 are connected by a capacitor 78 of 0.1 microfarad.

It may be noted that the oeprational amplifiers 58, 62 are in a single chip and each amplifies the difference between the plus and minus inputs with a gain of approximately 100,000 with extremely low input currents of the order of nanoamps.

It may be noted that the charger circuit may supply the total current to the heater when sufficient current from an external source is available. Such would be the case if drawing from a car battery through its cigarette lighter receptacle.

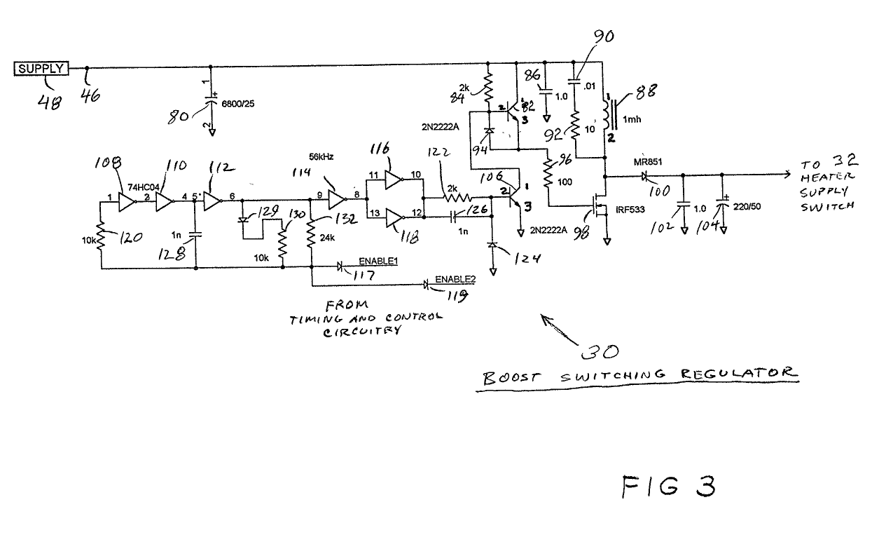

The substance of FIG. 2B is redundant to that the block diagram of FIG. 1 and the subsequent circuit diagrams of FIGS. 3 through 9, each of which depicts the circuit details of a respective block of the FIG. 1 diagram. Accordingly, in the cause of brevity and conciseness of this specification, a detailed delineation of the circuit elements of FIG. 2B per se is omitted. The reference numbers of the elements of FIG. 2B correspond precisely with those of their respective elements in the separate circuit diagrams of the subsequent figures. It may be deemed helpful to the description therein of their relationships to note the dashed lines on FIG. 2B outlining the separate and respective circuit blocks of the later figures: the boost switching regulator30, the heater supply switch 32, the temperature sensing circuitry 42, the drive level translator 38, the time and control circuit 34, the timing pulse generator 40, and the heater element 33.

FIG. 3 illustrates the circuit details of the boost switching regulator 30. This is a high frequency boost converter to reduce inductor and capacitor component size; and a voltage boost allows for higher heater resistance and lighter gage leads to the heater. The system supply output 46 is coupled to ground through an electrolytic capacitor 80 of 25 microfarads, to terminal 2 of a transistor 82 (2N2222A) through a 2 k-ohm resistor 84, to terminal 1 of the transistor 82, to ground through a 1 microfarad capacitor 86, to terminal 1 of a millihenry inductance 88, and through a 0.01 microfarad capacitor 90 in series with a 10 ohm resistor 92 to terminal 2 of the inductance 88. Terminal 2 of the transistor 82 is also coupled through a diode 94 to terminal 3 of the transistor 82 and through a 100 ohm resistor 96 to the gate of a IRF533 VMOS transitor 98 which in turn is connected between terminal 2 of the inductance 88 and ground. Terminal 2 of the inductance 88 is also connected through an MR851 diode 100 to the heater supply switch 32. The output of the diode 100 is coupled to ground by a 1 microfarad capacitor 102 and a parallel 50 microfarad electrolytic capacitor 104.

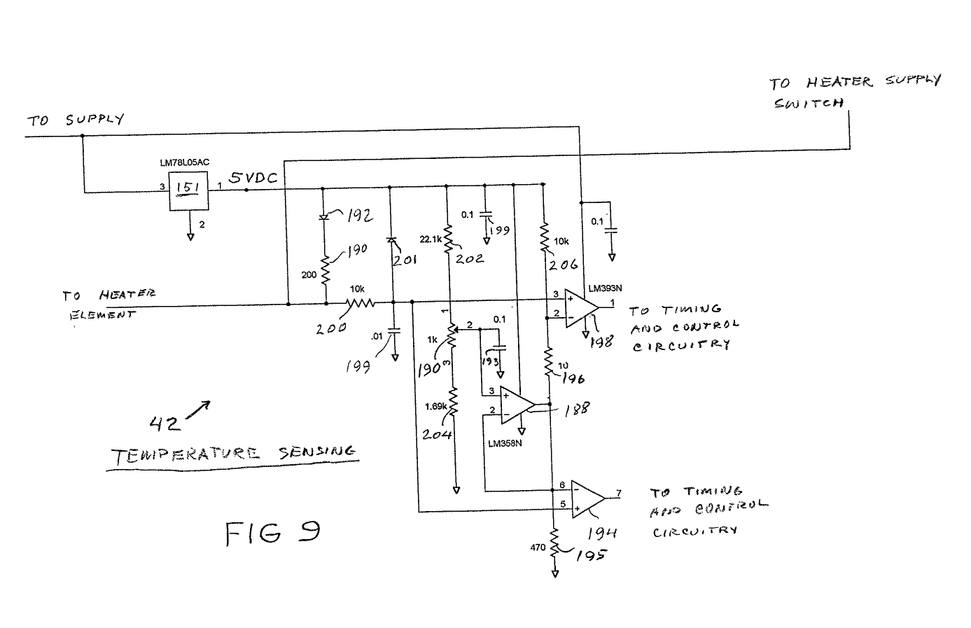

Terminal 1 of a 2N2222A transistor 106 is connected to terminal 2 of the transistor 82; and the terminal 2 of the transistor 106 is fed by the regulator logic circuitry of six logic gates, in one 74HCO4 chip, 108, 110, 112, 114, 116, and 118. Enable signals from the timing and control circuitry 34 (FIG. 8) are impressed through respective diodes 117, 119 upon the input of the gate 108 through a 10 k-ohm resistor 120; and the output of the gate 108 is coupled to the input of the gate 110, the output of which in turn is connected to the input of the gate 112; and its output is coupled to the input of the gate 114. The gates 116, 118 are connected in parallel with their inputs connected to the gate 114 and their outputs connected through a 2 k-ohm resistor 122 to the terminal 2 of the transistor 106 which is coupled to ground through a diode 124 which is also connected to the output of the gates 1 16, 118 through a I nanofarad capacitor 126. A nanofarad capacitor 128 is coupled between the diodes 117, 119 and the input of the gate 112; a series diode 129 and 10 k-ohm resistor 130 are connected between the input to the gate 114 and the diodes 117, 119; and a 24 k-ohm resistor 132 is coupled between the input to the logic gate 114 and the diodes 117, 119.

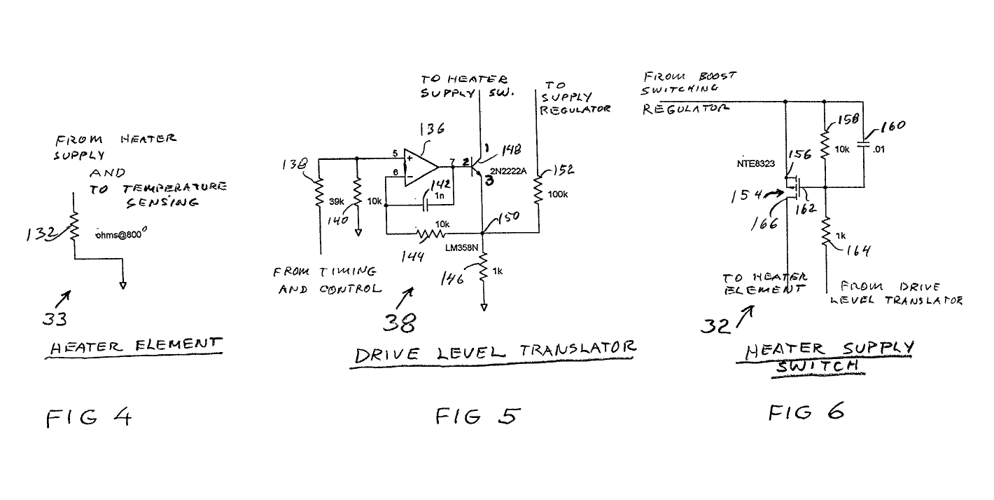

In FIG. 4 a heating element 134 is shown and may be noted to be, in this example, of the character of a resistive coating deposited on a ceramic base—usually cylindrical—and having a positive temperature resistance coefficient such that its electrical resistance is a usefully sensitive function of its temperature. As discussed below, during a short “off” portion, i.e. 5%, of its energizing duty cycle, its resistance is measured to determine its temperature and to increase or decrease, as required, current to the heater element. In this example, the resistance of the element 134 is approximately 20 ohms at 800 degrees F. The heater element 134 is designed to operate nominally at 24 volts; however, in this example the normal quiescent voltage applied is approximately 12 volts but may be boosted here to 30 volts when desired for heavy demand or recovery.

Referring to FIG. 5, the drive level translator 38 operates to translate a positive going 5VDC logic level, referenced to ground, to a 10 VDC level referenced to the heater supply. The input of an LM358N operational amplifier 136 is fed to its terminal 5 through a 36 k-ohm resistor 138 and that terminal is connected to ground through a 10 k-ohm resistor 140. Terminal 6 is coupled to the output terminal by a 1 nanofarad capacitor 142 and through a 10 k-ohm resistor 144 and a 1 k-ohm resistor 146 to ground. Terminal 2 of a 2N2222A transistor 148 is connected to terminal 7 of the amplifier 136 while its terminal 3 is connected to the junction 150 of the resistors 144, 146. The junction 150 is also coupled through a 100 k-ohm resistor 152 to the 5 VDC regulated output terminal 1 of a regulator chip 151 (LM78LO5AC) shown in FIG. 9 below. Terminal 1 of the amplifier 148 is coupled to the heater supply switch 32.

In FIG. 6 the heater supply switch 32 is seen to comprise an NTE8323 MOSFET or VMOS transistor 154 having its “source” terminal 156 coupled to the boost switching regulator 30 and through a parallel 10 k-ohm resistor 158 and 0.01 microfarad capacitor 160 to its gate terminal 162 which is connected to the drive level translator 38 through a 1 k-ohm resistor 164. The “drain” terminal 166 of the VMOS transistor 154 is connected to the heater element 33 of FIG. 4.

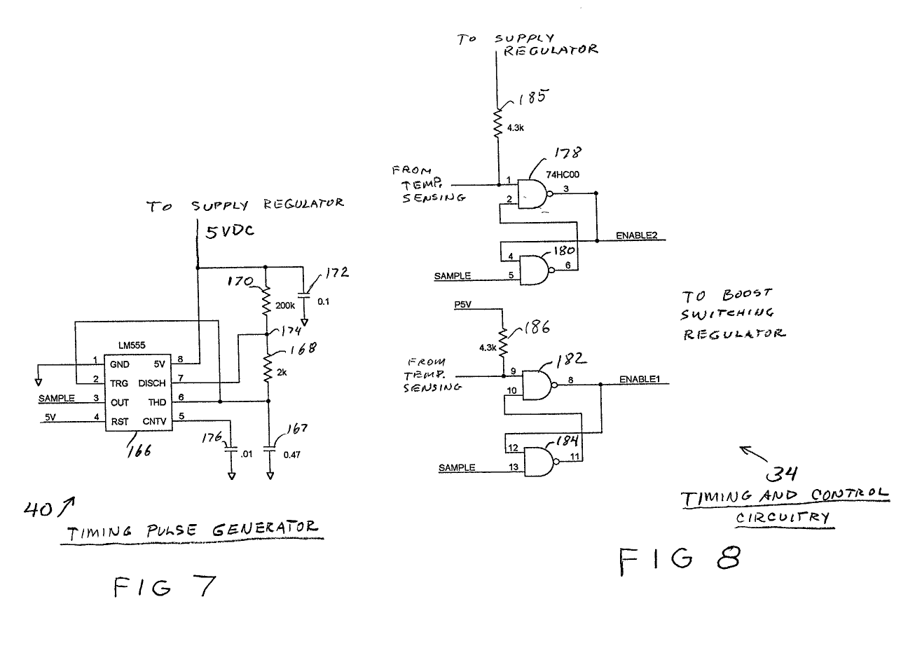

Referring to FIG. 7 the timing pulse generator 40 consists, in this example, primarily of a timer-pulse generator in a single chip LM 555 timer 166. Its terminal 8 is connected to the regulated source 151 (FIG. 9); its terminal 6 is connected to ground by a 0.47 microfarad capacitor 167 and through a 2 k-ohm resistor 168 in series with a 200 k-ohm resistor 170 to the source 151 (FIG. 9) which is coupled to ground by a 0.1 microfarad capacitor 172; its terminal 7 is connected to the junction 174 between the resistors 168, 170; its terminal 5 is coupled to ground by a 0.01 microfarad capacitor 176; its terminal 2 is connected to its terminal 6; its terminal 1 is grounded; and its “sample” terminal 3 is coupled to the “sample” terminals of logic gates of the timing and control circuitry 34 of FIG. 8.

With reference then to FIG. 8, the timing and control circuitry consists primarily of 4 logical NAND gates 178, 180, 182, 184 in a single chip 74HC00. The gates 178, 180 constitute a pair in combination, with the input terminal 1 coupled to the temperature sensing circuitry (FIG. 9), and through a 4.3 k-ohm resistor 185 to the supply regulator; its output terminal 3 is connected to terminal 4 of the gate 180 and to the “enable 2” input of the boost switching regulator 30 (FIG. 3); and its terminal 2 is connected to the output terminal 6 of the gate 180. The other input terminal 5 of the gate 180 is connected to the “sample” pulse output of the timing pulse generator 40 (FIG. 7). The other pair of gates 182, 184 are similarly connected: the gate 182 has its terminal 9 coupled to the supply regulator through a 4.3 k-ohm resistor 186 and to the temperature sensing circuitry (FIG. 9); its output terminal 8 is connected to the “enable 1” input of the boost switching regulator 30 (FIG. 3) and to the terminal 12 of the gate 184; and its terminal 10 is connected to the output terminal 11 of the gate 184 whose input terminal 13 is coupled to the “sample” terminal of the timing pulse generator 40 (FIG. 7). It may be noted that it is the character of the NAND gates that, for each, when either input is low, its output is high; when both inputs are high, its output is low. The NAND gates may also be considered to be inverted AND gates.

Referring to the temperature sensing circuit 42 of FIG. 9, it is basically a two stage implementation with the first step being an operational amplifier 188 for sensing temperature and set at approximately 10 degrees below the main temperature set point which is controlled by a front panel potentiometer 190. The heater and boost switches are set below this temperature. The second stage is the main sensing circuit: only the heater element supply switch is set when the element temperature is below the main set point. The sensing circuit is a pair of voltage comparators that compare the main temperature set point voltage with the heater element voltage, which is the voltage across the element during that 5% of its duty cycle when no power is applied; and that voltage is its instantaneous resistance (a function of its temperature) multiplied by a predetermined bias current developed through a 200 ohm bias resistor 190 and its series diode 192 connected to the 5VDC supply.

The operational amplifier 188, which may be the other half of the amplifier 136 of the drive level translator (FIG. 5), has its terminal 3 connected to the moving contact of the panel potentiometer 190 and to ground by a 0.1 microfarad capacitor 193; its terminal 2 is connected to terminal 6 of an LM 393N comparator 194 and through a 470 ohm resister 195 to ground; and its output terminal is connected to terminal 6 of the comparator 194 as well as, through a 10 ohm resistor 196, to terminal 2 of a comparator 198, the other half of LM393N. The input terminals 5, 3, respectively, of the comparators 194, 198 are coupled to ground by a 0.01 microfarad capacitor 199, to the 5VDC supply by a diode (201) and through a 10 k-ohm resistor 200 to the heater element 33 (FIG. 4). A 0.1 microfarad capacitor 203 couples the supply to ground. The temperature setting potentiometer 190 is the mid element of a voltage divider series connected from the 5VDC supply to ground and consisting of a 22.1 k-ohm resistor 202, the panel potentiometer 190, and a 1.69 k-ohm resistor 204. Terminal 2 of the comparator 198 is connected to the 5VDC supply through a 10 k-ohm resistor 206.

There has thus been set forth an example of a portable soldering station which has an integral charging circuit for producing a constant charging current of 0.8 volts until a battery voltage of 13.8 is reached. Above 13.8 volts, the gel cell battery may be charged continuously indefinitely. The soldering iron draws power from an external battery, the charging circuit, or the internal battery depending upon the available power and the demand from the heater. Power transfer between the sources is automatic. The voltage boost circuit supplies a voltage of approximately 30 volts to the heater as the load demands while normal voltage to the heater is approximately 12 volts. The two stage voltage system limits demands on the battery during idle or quiescent conditions and only boosts the voltage as required to maintain control to the set temperature.

1. A portable electric soldering system comprising:
A. an electric resistive heating element for applying solder melting heat to a soldering tip;
B. power supply means including
i. an internal rechargeable battery
ii. charger supply means for drawing electric power from external sources
iii. battery charger means coupled to said battery and to said charger supply means for charging said battery;
C. boost switching regulator means coupled to said power supply means for converting the direct current output thereof to higher voltage, high frequency power;
D. heater supply means coupled to said regular means and to said heating element and being of the character to provide power thereto with a duty cycle including a cyclical, brief, temperature measuring dead time; and
E. temperature sensing and control means coupled to said heating element and to said heater supply means for measuring the electric resistance of said heating element during said cyclical dead time as a function of its temperature and providing a control signal to said heater supply means whereby, in response thereto, said heater supply means applies power to said heating element to maintain its temperature within a predetermined range.

2. The system as set forth in claim 1 in which said battery is a gel lead acid battery having a nominal voltage of 12 volts.

3. The system as set for the in claim in which the nominal design rating of said heating element is 24 volts and dissipation approximately 30 watts at the rating.

4. The system as set forth in claim 1 in which said temperature sensing and control means includes comparator means for comparing a predetermined, operator set temperature with that of said heating element during said cyclical dead time to provide said control signal to said heating supply means.

5. A portable electric soldering system comprising:
A. a charger supply circuit adapted to be coupled to external power sources and having an output,
B. an internal 12 volt battery;
C. a charging circuit having an input and an output, its output being coupled to the output of said charger supply circuit and its input being coupled to said battery;
D. a high frequency voltage boost switching regulator circuit having first and second inputs and an output, its first input being coupled to the output of said charging circuit;
E. a heater element supply switch circuit having first and second inputs and an output, its first input being coupled to said output of said boost switching regulator circuit;
F. a heater element having a time shared input coupled to said heater element supply switch circuit;
G. a temperature sensing circuit having an input and an output, its input being coupled to said time shared input of said heater element;
H. a timing and control circuit having first and second inputs and first and second outputs, its first output being coupled to said second input of said boost switching regulator circuit, its first input being coupled to said output of said temperature sensing circuit; and
I. a timing pulse generator having an output coupled to said second input of said timing and control circuit.

6. The system as set forth in claim 5 which further includes a drive level translator having an input and an output, its input being coupled to said second output of said timing and control circuit and its output being coupled to said second input of said heater element supply switch circuit.
